(19) United States
(12) Patent Application Publication
(10) Pub. No.: US 2025/0105503 A1
(43) Pub. Date: Mar. 27, 2025

(54) CURVED PHASED ARRAY ANTENNA

(71) Applicant: The MITRE Corporation, McLean, VA (US)

(72) Inventors: John P. LISTON, Wilmington, MA (US); Mohamed Wajih ELSALLAL, Acton, MA (US)

(73) Assignee: The MITRE Corporation, McLean, VA (US)

(21) Appl. No.: 18/894,800

(22) Filed: Sep. 24, 2024

Related U.S. Application Data
(60) Provisional application No. 63/540,229, filed on Sep. 25, 2023.

(51) Int. Cl. H01Q 3/34; H01Q 1/48

(52) U.S. Cl. CPC H01Q 3/34; H01Q 1/48

(57) ABSTRACT

Curved phased array antennas are provided herein. In some embodiments, a phased array antenna includes a base plate comprising a first curved surface; and a plurality of radiating elements, wherein a first radiating element of the plurality of radiating elements comprises: a signal ear projecting outwardly from the first curved surface; and a ground ear projecting outwardly from the first curved surface and spaced in at least a circumferential direction of the first curved surface of the base plate from the signal ear, wherein a first surface of the signal ear facing a first surface of the ground ear is parallel to the first surface of the ground ear.

### CROSS REFERENCE TO RELATED APPLICATIONS

This application claims priority to U.S. Provisional Application No. 63/540,229, filed Sep. 25, 2023, the entire contents of which is incorporated herein by reference.

### FIELD

This disclosure relates generally to antennas, and more specifically to phased array antennas.

### BACKGROUND

There are increasing demands for phased array antennas tailored for various applications, such as satellite communications (SATCOM), radar, remote sensing, direction finding, and other systems. Demands include more flexibility in antenna configuration and functionality at reduced cost with consideration to limited space, weight, and power consumption (SWaP) on modern military and commercial platforms.

A phased array antenna is an array of antenna elements in which the phases of respective signals feeding the antenna elements are set in such a way that the effective radiation pattern of the array is reinforced in a desired direction and suppressed in undesired directions, thus forming a beam. The relative amplitudes of constructive and destructive interference effects among the signals radiated by the individual elements determine the effective radiation pattern of the phased array. The number of antenna elements in a phased array antenna is often dependent on the required gain of a particular application and can range from isotropic to highly directive level.

Conventional phased array antennas include an array of antenna elements that extend from a planar base plate. Such conventional phased array antennas are suitable for many applications but may be unsuitable for applications requiring coverage beyond that provided due to the planar arrangement of the antenna elements. Additionally, the signal gain of conventional phased array antennas including elements extending from a planar based plate decreases as the signal transmission direction moves away from a direction perpendicular to the planar base plate (i.e., “broadside”). Specifically, in a conventional antenna with elements radiating from a planar base plate, the gain drops as a function of the angle from broadside. At 60 degrees from broadside a phased array antenna exhibits about half the gain as produced at broadside and exhibits zero signal gain 90 degrees from broadside. Accordingly, to obtain full coverage using conventional phased array antennas, several antennas must be mounted at varying angles, or a mechanically rotating phased array antenna must be used, thus increasing installation and/or operational complexities.

### SUMMARY

Described herein are exemplary cylindrical, conformal, or otherwise curved phased array antennas that improve upon the shortcomings of the conventional phased array antennas described above. According to various embodiments, a phased array antenna includes a plurality of radiating elements projecting outwardly from a curved surface of a base plate.

A radiating element may include a signal ear and a ground ear spaced apart from one another in at least a circumferential direction of the curved surface of the base plate. The signal and ground ears may each include posts that extend from the base plate and are spaced apart by a gap. Surfaces of each post that face one another and define the gap extend parallel to one another. Thus, even though the signal and ground ears extend from a curved surface, the surfaces of their posts remain parallel with each other so that the gap has a consistent width.

According to some embodiments, the signal ear of a radiating element is spaced from and capacitively couples to an adjacent conductive element. The adjacent conductive element can be, for example, a ground ear of an adjacent radiating element or a clustered pillar connected to the base plate. The signal ear may be spaced by a gap that has a constant width between a surface of the signal ear and a surface of the adjacent conductive element that define the gap.

In some embodiments, the base plate of the phased array antennas described herein may be a cylinder, semicylinder, sphere, or hemisphere, or may be configured to conform to any curved surface. In some embodiments, the base plate may be a module forming a segment of any of the aforementioned shapes.

An exemplary phased array antenna comprises: a base plate comprising a first curved surface; and a plurality of radiating elements, wherein a first radiating element of the plurality of radiating elements comprises: a signal ear projecting outwardly from the first curved surface; and a ground ear projecting outwardly from the first curved surface and spaced in at least a circumferential direction of the first curved surface of the base plate from the signal ear, wherein a first surface of the signal ear facing a first surface of the ground ear is parallel to the first surface of the ground ear.

In some embodiments, the ground ear is spaced in a longitudinal direction of the first curved surface of the base plate from the signal ear.

In some embodiments, a second surface of the signal ear is configured to capacitively couple with a first surface of a ground ear of a second radiating element, wherein the second surface of the signal ear faces away from the first surface of the signal ear and is not parallel to the first surface of the signal ear.

In some embodiments, the second surface of the signal ear of the first radiating element is parallel to the first surface of the ground ear of the second radiating element.

In some embodiments, a plane associated with at least one of the first surface of the signal ear and the first surface of the ground ear does not intersect a center of curvature of the first curved surface.

In some embodiments, an outer end of the ground ear and an outer end of the signal ear are aligned in an arc.

In some embodiments, the arc is concentric with the first curved surface of the base plate.

In some embodiments, the base plate forms at least a portion of a hollow cylinder.

In some embodiments, the signal ear comprises a first post projecting outwardly from the first curved surface, wherein the first post is electrically isolated from the base plate.

In some embodiments, the first post of the signal ear comprises the first surface of the signal ear facing the first surface of the ground ear.

In some embodiments, the signal ear comprises a second post projecting outwardly from the first curved surface of the base plate, wherein the second post is directly integrated into the base plate.

In some embodiments, the first post of the signal ear extends beyond the first curved surface of the base plate into the base plate to connect to a feed line.

In some embodiments, the first post of the signal ear connects to the feed line by contacting a connector electrically connected to the feed line.

In some embodiments, the ground ear comprises a post projecting outwardly from the first curved surface of the base plate, wherein the post is directly integrated into the base plate.

In some embodiments, the post of the ground ear comprises the first surface of the ground ear facing the first surface of the signal ear.

In some embodiments, the signal ear comprises a first post and the ground ear comprises a post, wherein the first post of the signal ear comprises the first surface of the signal ear and wherein the post of the ground ear comprises the first surface of the ground ear.

In some embodiments, the phased array antenna further comprises a third radiating element, wherein the third radiating element projects outwardly from the first curved surface of the base plate, wherein the third radiating element is positioned orthogonally to the first radiating element.

In some embodiments, the third radiating element comprises a signal ear and a ground ear, and wherein a plane associated with first surface of the signal ear of the third radiating element intersects a center of curvature of the first curved surface, wherein the first surface of the signal ear of the third radiating element is positioned on a post of the signal ear of the third radiating element facing a surface on a post of the ground ear of the third radiating element.

In some embodiments, the base plate of the phased array antenna is a semicylinder.

In some embodiments, the base plate of the phased array antenna is a cylinder.

In some embodiments, the base plate of the phased array antenna is a hollow sphere.

In some embodiments, the phased array antenna is configured for mounting to a vehicle.

In some embodiments, any one or more of the characteristics of any one or more of the embodiments described above may be combined, in whole or in part, with one another and/or with any other features or characteristics described elsewhere herein.

### BRIEF DESCRIPTION OF THE FIGURES

FIG. 1A illustrates a plan view of a general dual-polarized phased array antenna according to some examples.

FIG. 1B illustrates a unit cell of a general dual-polarized phased array antenna according to some examples.

FIG. 1C illustrates a unit cell of a general dual-polarized phased array antenna with clustered pillars according to some examples.

FIG. 2 illustrates a plan view of an alternative polarization arrangement for a dual-polarized phased array antenna according to some examples.

FIG. 3A illustrates a side view of a partial unit cell of a phased array antenna according to some examples.

FIG. 3B illustrates a different side view of a partial unit cell of a phased array antenna according to some examples.

FIG. 3C illustrates an isometric view of a partial unit cell of a phased array antenna according to some examples.

FIG. 4A illustrates a first side view (looking into the longitudinal direction of a cylindrical phased array antenna) of a module of a cylindrical or semicylindrical phased array antenna.

FIG. 4B illustrates a second side view (looking into the circumferential direction of a cylindrical phased array antenna) of a module of a cylindrical or semicylindrical phased array antenna.

FIG. 4C illustrates an isometric view of the module of FIGS. 4A and 4B.

FIG. 5 illustrates a first exemplary cylindrical phased array antenna according to some examples.

FIG. 6 illustrates a second exemplary cylindrical phased array antenna according to some examples.

FIG. 7A illustrates a concave phased array antenna and dielectric lens according to some examples.

FIG. 7B illustrates a detail view of a radiating element of the concave phased array antenna of FIG. 7A.

FIG. 8 illustrates a spherical phased array antenna according to some examples.

FIG. 9 illustrates exemplary cylindrical phased array antennas stacked to provide coverage over different frequency bands according to some examples.

FIG. 10A illustrates exemplary aspects of a cylindrical or semi-cylindrical phased array antenna according to some examples.

FIG. 10B illustrates a detail view of aspects of the phased array antenna of FIG. 10A according to some examples.

### DETAILED DESCRIPTION

Described herein, according to various embodiments, are curved (e.g., cylindrical, semicylindrical, spherical, etc.) phased array antennas. In some embodiments, a phased array antenna includes a plurality radiating elements projecting outwardly from a curved surface of a base plate.

According to certain embodiments, a radiating element includes a signal ear and a ground ear projecting outwardly from the curved surface of the base plate. The signal ear and ground ear may be spaced apart from one another along the curved surface in at least a circumferential direction of the base plate such that a gap is formed between a post of the signal ear and a post of the ground ear. Surfaces of each post that face one another and define the gap extend parallel to one another. Accordingly, the signal ear and ground ear are configured such that a gap with a consistent width is maintained between surfaces of the signal ear and ground ear posts irrespective of the curvature of the base plate.

According to certain embodiments, a surface of a radiating element is configured to capacitively couple with a surface of an adjacent conductive element, such as an adjacent radiating element or clustered pillar connected to the base plate. For instance, a signal ear of a radiating element may include a surface that faces a surface of an adjacent ground ear and may capacitively couple with the surface of the adjacent ground ear during signal reception and transmission. The respective surfaces of the signal and ground ear of adjacent radiating elements may be parallel to one another and define a gap having a constant width along the length of the surfaces. Accordingly, the radiating elements of the curved phased array antennas described herein may be configured to mitigate any impact of the antenna's curvature on antenna performance by ensuring that gaps between adjacent radiating elements, and their respective signal and ground ears, are maintained at a constant width.

In some embodiments, the base plate of the phased array antennas described herein may be formed into a variety of curved surfaces, such as a cylinder, semi-cylinder, hemisphere, sphere, and so on. The phased array antennas herein may also be operable as discrete modules that can be fitted together to form one or more of the aforementioned shapes. According to certain embodiments, the cylindrical, semi-cylindrical, spherical, hemispherical, conformal, and otherwise curved phased array antennas can provide full uniform coverage about the entirety of the curved surface of the phased array. Additionally, due to the curvature, the curved phased array antennas described herein may provide enhanced signal gain at all transmission angles relative to a planar array, which loses signal gain at increasing angles relative to broadside. Signal gain about a cylindrical or semi-cylindrical array would remain relatively constant due to the curvature because at least some of the transmitting and/or receiving elements would be positioned perpendicularly to the direction of transmission and/or reception.

In some embodiments, the phased array antennas described herein may be configured for mounting to various land, water, and/or aerial vehicles. Accordingly, up to 360-degree coverage can be provided for such vehicles using a single antenna, for instance, mounted to the top of an autonomous car or the mast of a ship. In some examples, the phased array antennas described herein may be configured for mounting to stationary objects such as buildings. For instance, a semi-cylinder could be configured for mounting to a side of a building to provide 180-degrees of signal coverage to that side of the building.

In the following description of the disclosure and embodiments, reference is made to the accompanying drawings in which are shown, by way of illustration, specific embodiments that can be practiced. It is to be understood that other embodiments and examples can be practiced and changes can be made without departing from the scope of the disclosure.

In addition, it is also to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units, but do not preclude the presence or addition of one or more other features, integers, steps, operations, elements, components, units, and/or groups thereof.

Reference is sometimes made herein to an array antenna having a particular configuration (e.g. a cylindrical array). One of ordinary skill in the art would appreciate that the techniques described herein are applicable to various sizes and curved or arcuate shapes of phased array antennas. It should thus be noted that although the description provided herein primarily describes the concepts in the context of cylindrical, semicylindrical, or hemispherical phased array antennas, those of ordinary skill in the art would appreciate that the concepts equally apply to other sizes and shapes of array antennas including, but not limited to conical, spherical, and arbitrarily shaped conformal array antennas.

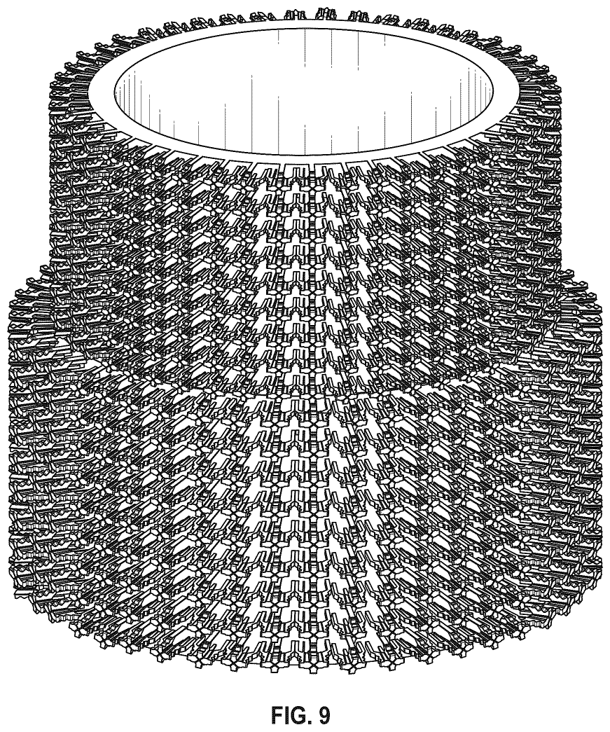

Reference is also made herein to the array antenna including radiating elements of a particular size and shape. For example, certain embodiments of radiating element are described having a shape and a size compatible with operation over a particular frequency range (e.g. 1-6 GHz or 3-18 GHz). Those of ordinary skill in the art would recognize that other shapes of antenna elements may also be used and that the size of one or more radiating elements may be selected for operation over any frequency range in the RF frequency range (e.g. any frequency in the range from below 20 MHz to above 50 GHz). Further, antennas configured for different frequency ranges and/or bandwidths may be stacked on top of one another, for instance, as shown in FIG. 9. A stack of antennas configured to operation over different frequency ranges/bandwidths can provide for additional coverage over a single antenna.

Reference is sometimes made herein to generation of an antenna beam having a particular shape or beam width. Those of ordinary skill in the art would appreciate that antenna beams having other shapes and widths may also be used and may be provided using known techniques such as by inclusion of amplitude and phase adjustment circuits into appropriate locations in an antenna feed circuit.

Described herein are embodiments of frequency-scaled ultra-wide spectrum phased array antennas. These phased array antennas are formed of repeating cells of frequency-scaled ultra-wide spectrum radiating elements. Phased array antennas according to certain embodiments exhibit very low profile, wide bandwidth, low cross-polarization, and high scan-volume while being low cost, small aperture, modular with built-in RF interconnect, and scalable.

A unit cell of a frequency-scaled ultra-wide spectrum phased array antenna, according to various embodiments, includes a pattern of radiating elements. According to various embodiments, the radiating elements are formed of substrate-free, interlacing components that include a pair of metallic ears (e.g., solid metal or metal plating of a non-metallic substrate such as plastic) that form a coplanar transmission line. In some embodiments, one of the ears is the ground component of the radiating element and can be terminated directly to the array's base plate and the other ear is the signal or active line of the radiating element and can be connected to a feed line. The radiating elements of each unit cell can be arranged orthogonally relative to one another, with a first radiating element (i.e., a first signal ear and ground ear) arranged in a first plane that is orthogonal to the plane that the second radiating element occupies. In some embodiments, the one of the two radiating elements might be removed or replaced with another structure.

In some embodiments, each of the ears of the radiating elements are signal or active lines and can be connected to respective feed lines, thus forming a differential pair of signal ears. According to certain embodiments, the edge of the radiating elements (the edge of the ears) are shaped to encapsulate a metallic clustered pillar (the clustered pillars can have any shape and form, such as a cross-shape, rectangular shape, circular shape, etc.), which controls the capacitive component of the antenna and can allow good impedance matching at the lower-frequency end of the bandwidth, effectively increasing the operational bandwidth. This has the advantage of a phased array antenna in which no wideband impedance matching network or special mitigation to a ground plane is needed. According to certain embodiments, capacitive coupling may be achieved between two radiating elements directly adjacent to one another, omitting the clustered pillar. For instance, a signal ear may capacitively couple directly to an adjacent signal ear or an adjacent ground ear. Radiating elements can be for transmit, receive, or both. Phased array antennas can be built as single polarized or dual polarized by implementing the appropriate radiating element pattern, as described below.

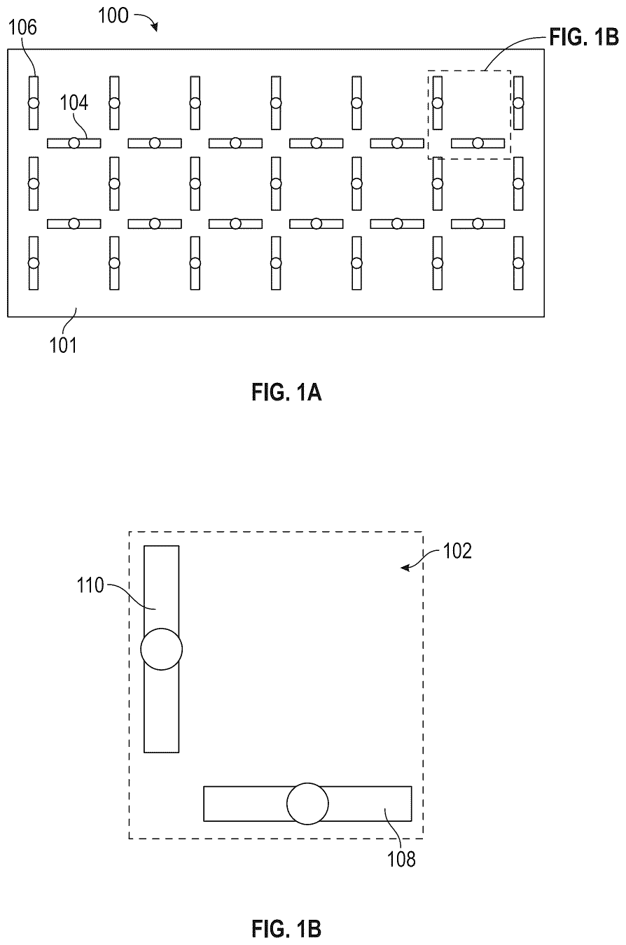

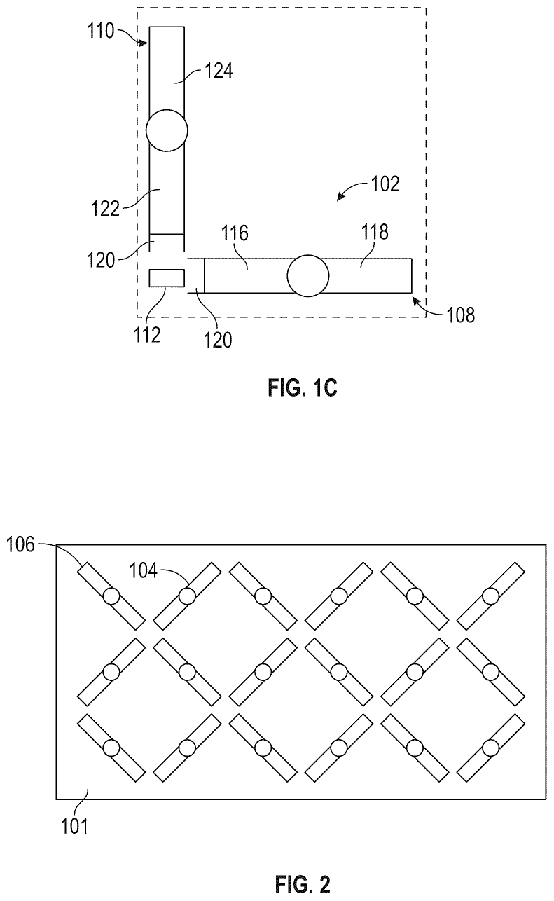

FIGS. 1A-1C and FIG. 2, described below, provide description of various components and characteristics of phased array antennas that may be applied to any of the embodiments described herein. In FIG. 1A, a plan view of an exemplary cylindrical or semi-cylindrical phased array antenna 100 (or segment/module of a cylindrical phased array antenna) with a dual polarized configuration is shown with radiating elements 106 oriented in a first direction and radiating elements 104 oriented in a second direction. In some embodiments, the first direction may be a circumferential direction (along a curved surface) of a cylindrical or semi-cylindrical phased array antenna and the second direction may be a longitudinal direction (along the height) of a cylindrical or semi-cylindrical phased array antenna.

In some embodiments, a unit cell 102 (as shown in FIG. 1B) includes a single radiating element 110 oriented in the first direction and a single radiating element 108 oriented in the second direction. Phased array antenna 100 is a 3×5 array of unit cells 102. According to certain embodiments, array 100 can be scaled up or down to operate over a specified frequency range. More unit cells can be included, or unit cells can be removed, to meet other specific design requirements such as antenna gain. According to certain embodiments, modular arrays of a predefined size may be combined into a desired configuration to create an antenna array to meet the required performance. For example, a module may include the 3×5 array of radiating elements 104 and 106 illustrated in FIG. 1A. A particular antenna application requiring 120 radiating elements can be built using eight modules fitted together into a cylindrical shape (thus, providing the 120 radiating elements). This modular design allows for antenna arrays to be tailored to specific design requirements at a lower cost.

As shown in FIG. 1B, radiating element 108 is disposed in a first direction and element 110 is disposed in a second direction that is orthogonal to the first direction, such that element 108 is substantially orthogonal to element 110. This orthogonal orientation results in each unit cell 102 being able to generate orthogonally directed electric field polarizations. That is, by disposing one set of elements (e.g. vertical elements 104) in one direction and disposing a second set of elements (e.g. horizontal elements 106) in the orthogonal direction, the antenna can generate signals having any polarization. In this particular example, unit cells 102 are disposed in a regular pattern, which here corresponds to a square grid pattern about a circumference of a portion of a cylindrical antenna. Those of ordinary skill in the art would appreciate that unit cells 102 need not all be disposed in a regular pattern.

In some applications, it may be desirable or necessary to modify the orientation of unit cells 102 and/or to modify the orientation of the radiating elements 108 and 110 on the base plate. Thus, although shown as a square lattice of unit cells 102, it would be appreciated by those of ordinary skill in the art that antenna 100 could include but is not limited to a rectangular or triangular lattice of unit cells 102 and that each of the unit cells can be rotated at different angles with respect to the lattice pattern. For example, FIG. 2 illustrates an antenna array of radiating elements according to certain embodiments where each of the unit cells 102 are rotated by 45 degrees relative to FIG. 1A, such that both sets of radiating elements 104 and radiating elements 106 are oriented partially in the first direction and partially in the second direction. In some embodiments, FIG. 2 is illustrative of a plan view of a cylindrical or semi-cylindrical phased array antenna. Accordingly, in such embodiments, the radiating elements of each orientation are respectively spaced apart from one another at least partially along a curved circumferential surface of the cylinder. In some embodiments, element 110 or 108 could be replaced by another structure (e.g., a differently shaped radiating element, a wall, etc.).

In some embodiments, each unit cell (e.g., unit cell 102) includes a signal ear 116 and ground ear 118. For instance, in the embodiment of FIG. 1A, radiating element 104 includes a signal ear 116 and ground ear 118. A signal beam is generated by exciting radiating element 104, i.e. by generating a voltage differential between signal ear 116 and ground ear 118. The generated signal beam has a direction along a centerline of radiating element 104, perpendicular to a curved surface of base plate 101. The centerline is the phase center of radiating element 104. A signal beam generated by exciting radiating element 104, has a phase center midway between its respective signal and ground ear. As shown in the embodiments of FIG. 1A, the phase centers of radiating elements 104 are not co-located with the phase centers of radiating elements 106.

In some embodiments, the radiating elements 104 are of a different size, shape, and spacing compared to radiating elements 106. However, in other embodiments, the radiating elements 104 may be of the same size, shape, and spacing as radiating elements 106. Phased array antennas according to some embodiments, may include only single polarized radiating elements (e.g., only rows of radiating elements 104). According to some embodiments, the spacing of one set of radiating elements (e.g., radiating elements 106) is different from the spacing of the other set of radiating elements (e.g., radiating elements 104). According to some embodiments, the radiating element spacing within a row may not be uniform. For example, the spacing between first and second radiating elements within a row may be different than the spacing between the second and third elements.

In some embodiments, radiating elements are shaped to capacitively couple with adjacent radiating elements oriented in the same direction. For instance, a signal ear may capacitively couple directly to an adjacent signal ear or an adjacent ground ear. This capacitance can be used to improve the impedance matching of the antenna. In some embodiments, a radiating element oriented in a first direction and a radiating element oriented in a second direction are positioned such that there is some capacitive coupling between the respective radiating elements. Capacitive coupling may be achieved between two radiating elements directly adjacent to one another, however, as shown in FIG. 1C, according to certain embodiments, the edges of the radiating elements (the edge of the ears) may optionally be shaped to encapsulate a metallic clustered pillar 112 (the clustered pillars can have any shape and form, such as a cross-shape, rectangular shape, circular shape, etc.) to capacitively couple to adjacent radiating elements during operation. This can enhance the capacitive component of the antenna, which allows a good impedance match at the low-frequency end of the bandwidth. Through this coupling of clustered pillar 112, each radiating element in a row or column is electromagnetically coupled to ground and the previous and next radiating element in the row or column.

Capacitive coupling is achieved by maintaining a gap 120 between respective radiating elements or between a radiating element and its adjacent clustered pillar, which creates interdigitated capacitance between the two opposing surfaces of gap 120. Capacitive coupling can be controlled by changing the overlapped surface area of gap 120 and width of gap 120 (generally, higher capacitance is achieved with larger surface area and less width). According to certain embodiments, gap 120 is less than 0.1 inches, preferably less than 0.05 inches, and more preferably less than 0.01 inches. According to some embodiments, gap 120 may be scaled with frequency (for example, gap 120 may be a function of the wavelength of the highest designed frequency, λ). For example, according to some embodiments, gap 320 can be less than 0.05λ, less than 0.025λ, or less than 0.013λ. According to some embodiments, gap 120 is greater than 0.005λ, greater than 0.01λ, greater than 0.025λ, greater than 0.05λ, or greater than 0.1λ.

According to certain embodiments, base plate 101 is formed from one or more conductive materials, such as metals like aluminum, copper, gold, silver, beryllium copper, brass, and various steel alloys. According to certain embodiments, base plate 214 is formed from a non-conductive material such as various plastics, including Acrylonitrile butadiene styrene (ABS), Nylon, Polyamides (PA), Polybutylene terephthalate (PBT), Polycarbonates (PC), Polyetheretherketone (PEEK), Polyetherketone (PEK), Polyethylene terephthalate (PET), Polyimides, Polyoxymethylene plastic (POM/Acetal), Polyphenylene sulfide (PPS), Polyphenylene oxide (PPO), Polysulphone (PSU), Polytetrafluoroethylene (PTFE/Teflon), or Ultra-high-molecular-weight polyethylene (UHMWPE/UHMW), that is plated or coated with a conductive material such as gold, silver, copper, or nickel. According to certain embodiments, base plate 101 is a solid block of material with holes, slots, or cut-outs to accommodate clustered pillars 112, signal ears 116 and 122, and ground ears 118 and 124 on the top (radiating) side and connectors on the bottom side to connect feed lines. In other embodiments, base plate 114 includes cutouts to reduce weight.

According to certain embodiments, base plate 101 is designed to be modular and includes features in the ends that can mate with adjoining modules (i.e., tiles). Such interfaces can provide both structural rigidity and cross-interface conductivity. Modules/tiles may be various sizes incorporating various numbers of unit cells of radiating elements. According to certain embodiments, a module/tile is a single unit cell. According to certain embodiments, modules/tiles are several unit cells (e.g., 2×2, 4×4), dozens of unit cells (e.g., 5×5, 6×8), hundreds of unit cells (e.g., 10×10, 20×20), thousands of unit cells (e.g., 50×50, 100×100), tens of thousands of unit cells (e.g., 200×200, 400×400), or more. According to certain embodiments, a module/tile is a rectangularly shaped curved portion of a cylinder or semicylinder rather than square shaped curved portion of a cylinder or semicylinder (i.e., more cells along one axis than along the other). According to certain embodiments, a module/tile is a curved portion of a hemisphere or sphere.

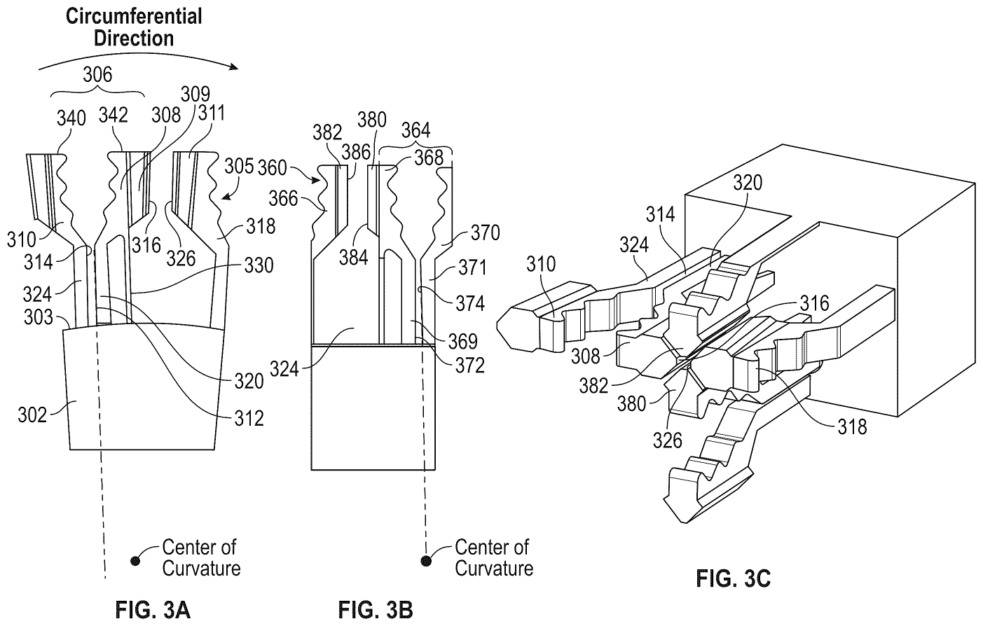

The base plate of the first module/tile may include partial cutouts along its edge to mate with partial cutouts along the edge of the next module/tile to form a receptacle to receive the radiating elements that fit between the ground clustered pillars along the edges of the two modules/tiles. According to certain embodiments, the base plate of a module/tile extends further past the last signal ear or ground ear along one edge (as shown in the unit cell of FIG. 3A) than it does along the opposite edge in order to incorporate a last set of receptacles used to receive the set of radiating elements that form the transition between one module/tile and the next. In these embodiments, the receptacles along the perimeter of the array remain empty. According to certain embodiments, a transition strip is used to join modules/tiles, with the transition strip incorporating a receptacle for the transition radiating elements. According to certain embodiments, no radiating elements bridge the transition from one module to the next. Arrays formed of modules/tiles according to certain embodiments can include various numbers of modules/tiles, such as two, four, eight, ten, fifteen, twenty, fifty, a hundred, or more.

In some embodiments, base plate 101 may be manufactured in various ways including machined, cast, or molded. In some embodiments, holes or cut-outs in base plate 101 may be created by milling, drilling, formed by wire EDM, or formed into the cast or mold used to create base plate 101. Base plate 101 can provide structural support for each radiating element and clustered pillar and provide overall structural support for the array or module. Base plate 101 may be of various thicknesses depending on the design requirements of a particular application. For example, an array or module of thousands of radiating elements may include a base plate that is thicker than the base plate of an array or module of a few hundred elements in order to provide the required structural rigidity for the larger dimensioned array. According to certain embodiments, the base plate is less than 6 inches thick. According to certain embodiments, the base plate is less than 3 inches thick, less than 1 inch thick, less than 0.5 inches thick, less than 0.25 inches thick, or less than 0.1 inches thick. According to certain embodiments, the base plate is between 0.2 and 0.3 inches thick. According to some embodiments, the thickness of the base plate may be scaled with frequency (for example, as a function of the wavelength of the highest designed frequency, λ). For example, the thickness of the base plate may be less than 1.0λ, 0.5λ, or less than 0.25λ. According to some embodiments, the thickness of the base plate is greater than 0.1λ, greater than 0.25λ, greater than 0.5λ, or greater than 1.0λ.

According to certain embodiments, radiating elements 104 and 106 and/or clustered pillar 112 may be formed from any one or more materials suitable for use in a radiating antenna. These may include materials that are substantially conductive and that are relatively easy to machine, cast and/or solder or braze. For example, one or more radiating elements 104 and 106 and/or clustered pillar 112 may be formed from copper, aluminum, gold, silver, beryllium copper, or brass. In some embodiments, one or more radiating elements 104 and 106 and/or clustered pillar 112 may be substantially or completely solid. For example, one or more radiating elements 104 and 106 and/or clustered pillar 112 may be formed from a conductive material, for example, substantially solid copper, brass, gold, silver, beryllium copper, or aluminum. In other embodiments, one or more radiating elements 104 and 106 and/or clustered pillar 112 are substantially formed from non-conductive material, for example plastics such as ABS, Nylon, PA, PBT, PC, PEEK, PEK, PET, Polyimides, POM, PPS, PPO, PSU, PTFE, or UHMWPE, with their outer surfaces coated or plated with a suitable conductive material, such as copper, gold, silver, or nickel.

In other embodiments, one or more radiating elements 104 and 106 and/or clustered pillars 112 may be substantially or completely hollow, or have some combination of solid and hollow portions. For example, one or more radiating elements 104 and 106 and/or clustered pillar 112 may include a number of planar sheet cut-outs that are soldered, brazed, welded or otherwise held together to form a hollow three-dimensional structure. According to some embodiments, one or more radiating elements 104 and 106 and/or clustered pillar 112 are machined, molded, cast, or formed by wire-EDM. According to some embodiments, base plate 101, one or more radiating elements 104 and 106 and/or clustered pillar 112 are 3D printed, for example, from a conductive material or from a non-conductive material that is then coated or plated with a conductive material.

In some embodiments, the phased array antenna 100, has a designed operational frequency range, e.g., 1 to 30 GHz, 2 to 30 GHz, 3 to 25 GHZ, and 3.5 to 21.5 GHZ. According to certain embodiments, the phased array antenna is designed to operate at a frequency of at least 1 GHz, at least 2 GHz, at least 3 GHZ, at least 5 GHz, at least 10 GHz, at least 15 GHz, or at least 20 GHz. According to certain embodiments, the phased array antenna is designed to operate at a frequency of less than 50 GHz, less than 40 GHZ, less than 30 GHz, less than 25 GHZ, less than 22 GHZ, less than 20 GHz, or less than 15 GHz. The sizing and positioning of radiating elements can be designed to effectuate these desired frequencies and ranges. For example, the spacing between a portion of a first radiating element and the portion of the next radiating element along the same axis may be equal to or less than about one-half a wavelength, λ, of a desired frequency (e.g., highest design frequency). According to some embodiments, the spacing may be less than 1λ, less than 0.75λ, less than 0.66λ, less than 0.33λ, or less than 0.25λ. According to some embodiments, the spacing may be equal to or greater than 0.25λ, equal to or greater than 0.5λ, equal to or greater than 0.66λ, equal to or greater than 0.75λ, or equal to or greater than 1λ.

Additionally, the height of radiating element 104 and 106 may be less than about one-half the wavelength of the highest desired frequency. According to some embodiments, the height may be less than 1λ, less than 0.75λ, less than 0.66λ, less than 0.33λ, or less than 0.25λ. According to some embodiments, the height may be equal to or greater than 0.25λ, equal to or greater than 0.5λ, equal to or greater than 0.66λ, equal to or greater than 0.75λ, or equal to or greater than 1λ. For example, according to certain embodiments where the operational frequency range is 2 GHz to 14 GHZ, with the wavelength at the highest frequency, 14 GHz, being about 0.84 inches, the spacing from one radiating element to another radiating element is less than about 0.42 inches. According to certain embodiments, for this same operating range, the height of a radiating element from the base plate is less than about 0.42 inches. In some embodiments, a cylindrical phased array is configured to operate in a frequency range of 1-6 GHz based partially on a radiating element height of 1.455 inches and unit cell spacing of 1.005 inches. In some embodiments, a cylindrical phased array antenna 600 is configured to operate in a frequency range of 3-18 GHz based partially on a radiating element height of 0.485 inches and a unit cell spacing of 0.335 inches.

It should be appreciated decreasing the height of the radiating elements can improve the cross-polarization isolation characteristic of the antenna. It should also be appreciated that using a radome (an antenna enclosure designed to be transparent to radio waves in the operational frequency range) can provide environmental protection for the array. The radome may also serve as a wide-angle impedance matching (WAIM) that improves the voltage standing wave ratio (VSWR) of the array at wide-scan angles (improves the impedance matching at wide-scan angles).

According to certain embodiments, more spacing between radiating elements eases manufacturability. However, as described above, a maximum spacing can be selected to prevent grating lobes at the desired scan volumes. According to certain embodiments, the selected spacing reduces the manufacturing complexity, sacrificing scan volume, which may be advantageous where scan volume is not critical. According to certain embodiments, the size of the array is determined by the required antenna gain. For example, for certain application over 40,000 elements are required. For another example, an array of 128 elements may be used for bi-static radar.

### Phased Array Antenna Unit Cell

FIG. 3A illustrates a first side view (e.g., looking into the longitudinal direction of a unit cell of a cylindrical phased array antenna) of a unit cell 301 that includes a radiating element 306 of a phased array antenna 300. Radiating element 306 includes a signal ear 308 and a ground ear 310 projecting outwardly from a first curved surface 303 of the base plate 302. In the exemplary phased array antenna 300 of FIG. 3, the signal ear 308 and ground ear 310 of radiating element 306 are spaced apart from one another in a circumferential direction of the first curved surface of the base plate 302.

The signal ear 308 includes a first surface 312 that faces a first surface 314 of the ground ear 310 and is parallel to the first surface 314 of the ground ear 310. In some embodiments, the signal ear 308 includes a first post 320 and the ground ear includes a post 324. In some embodiments, the first post 320 of the signal ear 308 includes the first surface 312 of the signal ear and the post 324 of the ground ear 310 includes the first surface 314 of the ground ear that faces the first surface 312 of the signal ear 308. Accordingly, the signal ear 308 and ground ear 310 may respectively include posts projecting outwardly from the first curved surface 303 of base plate 302, and the surfaces 312 and 314 of the respective posts 320 and 324 that face one another are parallel to each other.

In some embodiments, at least one of the first surface 312 of the signal ear 308 and the first surface 314 of the ground ear 310 do not intersect a center of curvature of the first curved surface. As described, the respective surfaces 312 and 314 of posts 320 and 324 are parallel to one another extending outwardly from the base plate 302. Accordingly, a plane on which each of the surfaces 312 and 314 respectively lie will extend into the base plate 302 and toward the center of curvature of the first curved surface. However, because the respective surfaces 312 and 314 are parallel to one another, at least one of the planes formed by the respective surfaces does not intersect the center of curvature of the first curved surface.

In some embodiments, signal ear 308 includes a second surface 316 that is positioned to capacitively couple with a first surface 326 of a ground ear 314 of an adjacent radiating element 305. The second surface 316 of the signal ear 308 faces away from the first surface 312 of the signal ear 308 and is not parallel to the first surface 312 of the signal ear 308. As shown in FIG. 3A, the second surface 316 of signal ear 308 is positioned on a capacitive coupling portion 309 of the signal ear 308 that extends toward a capacitive coupling portion 311 of the ground ear 318 of the second radiating element in the circumferential direction. In some embodiments, the capacitive coupling portions 309 and 311 include triangularly shaped portions such that other surfaces of the triangularly shaped portions of the capacitive coupling portions 309 and 311 can capacitively couple with surfaces on triangularly shaped capacitive coupling portions of radiating elements oriented orthogonally to radiating element 306, as shown in FIG. 3C.

In some embodiments, the capacitive coupling portion 309 of the signal ear 308 and the capacitive coupling portion 311 of ground ear 318 are configured to maintain a gap having a constant width between the capacitive coupling surfaces 316 and 326 along the length of surfaces 316 and 326. Specifically, in some embodiments, a bottom surface (i.e., closer to the base plate 302) of each of the respective capacitive coupling portions 309 and 311 is smaller than a top surface (i.e., further from the base plate 302) of each of the respective capacitive coupling portions 309 and 311 to account for the curvature of the base plate and maintain a gap having a constant width between surfaces 316 and 326. Maintaining constant gap width improves capacitive coupling between surfaces 316 and 326, thus impacting antenna performance.

In some embodiments, an outer end 340 of ground ear 310 and an outer end 342 of signal ear 308 are aligned in an arc. The arc may be concentric with the first curved surface 303 of the base plate 302. In some embodiments the base plate 302 of unit cell 301 forms at least a portion of a hollow cylinder. Accordingly, the base plate 302 of the phased array antenna 300 may be a hollow cylindrical base plate, and radiating elements arrayed about the longitudinal axis of the base plate 302 may form a cylindrical array of radiating elements.

In some embodiments, the first post 320 of signal ear 308 is electrically isolated from the base plate 302. Post 320 may extend beyond the first curved surface 303 of the base plate 302 into the base plate to connect to a feed line (not shown). The first post 320 may connect to the feed line by contacting a connector, such as an elastomeric connector, that is electrically connected to the feed line. In some embodiments, post 324 of ground ear 310 is connected to the first curved surface 303 of the base plate 302 and as such provides a path to ground between the ground ear 310 and the base plate 302. In some embodiments, the post 324 is directly integrated into the base plate 302. In some embodiments, signal ear 308 includes a second post 330 that is connected to base plate 302. In some embodiments, the second post 330 is directly integrated into the base plate 302. In other embodiments, post 330 can be removably attached to base plate 302. In some embodiments, the second post 330 of signal ear 308 serves as a support member for the signal ears 308. In some embodiments, second post 330 is electrically isolated from the base plate. In some embodiments, second post 330 is electrically connected to base plate 302 and provides a path to ground for signal ear 308. It should be understood that the second post 330 of signal ear 308 is optional, and the signal ear 308 may be electrically isolated from the base plate.

FIG. 3B illustrates a second side view (looking into the circumferential direction of a cylindrical phased array antenna) of the unit cell 302 that includes a radiating element 364 oriented orthogonally to radiating element 306. Radiating element 364 includes a signal ear 368 and a ground ear 370 projecting outwardly from the first curved surface 303 of base plate 302. The signal ear 368 and ground ear 370 of radiating element 364 are spaced apart from one another in the longitudinal direction of the first curved surface 303.

In some embodiments, the signal ear 368 includes a first surface 372 that faces a first surface 374 of the ground ear 370. In some embodiments, the signal ear 368 includes a first post 369 and the ground ear 370 includes a post 371. In some embodiments, the first post 369 of the signal ear 368 includes the first surface 372 and the post 371 of the ground ear 370 includes the first surface 374 of the ground ear 370 that faces the first surface 372 of the signal ear 368. Accordingly, similar to radiating element 306, the signal ear 368 and ground ear 370 may respectively include posts projecting outwardly from the first curved surface 303 of base plate 302, and the surfaces 372 and 374 of the respective posts 369 and 371 that face one another are parallel to each other. However, unlike radiating element 306, both of the surfaces 372 and 374 of the respective posts 369 and 371 may align with a plane that intersects the center of curvature of the first curved surface 303.

In some embodiments, the signal ear 368 of radiating element 364 is configured to capacitively couple with a ground ear 366 of an adjacent radiating element 360 oriented orthogonally to radiating element 306. In some embodiments, signal ear 368 and ground ear 366 include respective capacitive coupling portions 380 and 382 (as shown more clearly in FIG. 3C). An outer surface 384 of capacitive coupling portion 380 on signal ear 368 faces an outer surface 386 of capacitive coupling portion 382 on ground ear 366 and the respective surfaces 384 and 386 capacitively couple with one another during operation of the phased array antenna 300. In some embodiments, capacitive coupling surfaces 384 and 386 are parallel with surfaces 372 and 374. In other embodiments, the capacitive coupling surfaces 384 and 386 project from the base plate at a different angle from surfaces 372 and 374. In some embodiments, the capacitive coupling portions may include triangularly shaped portions such that other surfaces of the capacitive coupling portions 380 and 382 can capacitively couple with surfaces on the triangularly shaped portions of the capacitive coupling portions of radiating elements oriented orthogonally to radiating element 364.

FIG. 3C illustrates an isometric view of unit cell 302. As shown in FIG. 3C the signal ear 368 radiating element 364 and ground ear 366 of adjacent radiating element 360 include respective capacitive coupling portions 380 and 382, and the signal ear 308 of radiating element 306 and ground ear 318 of an adjacent radiating element 305 include respective capacitive coupling portions 309 and 311 (shown labeled in FIG. 3A). In some embodiments, the capacitive coupling portions of 309 and 311 of the radiating elements 305 and 306 are a first size and the capacitive coupling portions 380 and 382 of radiating elements 360 and 364 are a second size. In some embodiments, the capacitive coupling portions 309 and 311 of radiating elements 306 and 305, respectively, are larger than the capacitive coupling portions 380 and 382 of radiating elements 364 and 360 to account for the curvature of the first curved surface 303 of the base plate 302 and maintain a constant gap width between each of the capacitive coupling surfaces. Each of the capacitive coupling portions 309, 311, 380 and 382 may further be shaped to optimize capacitive coupling with the signal and ground ear that is orthogonal to its respective position. As shown in FIG. 3C, capacitive coupling portions 309, 311, 380 and 382 each include angled surfaces configured to capacitively couple to corresponding angled surfaces on signal or ground ears of adjacent orthogonally oriented radiating elements.

### Phased Array Antenna Modules

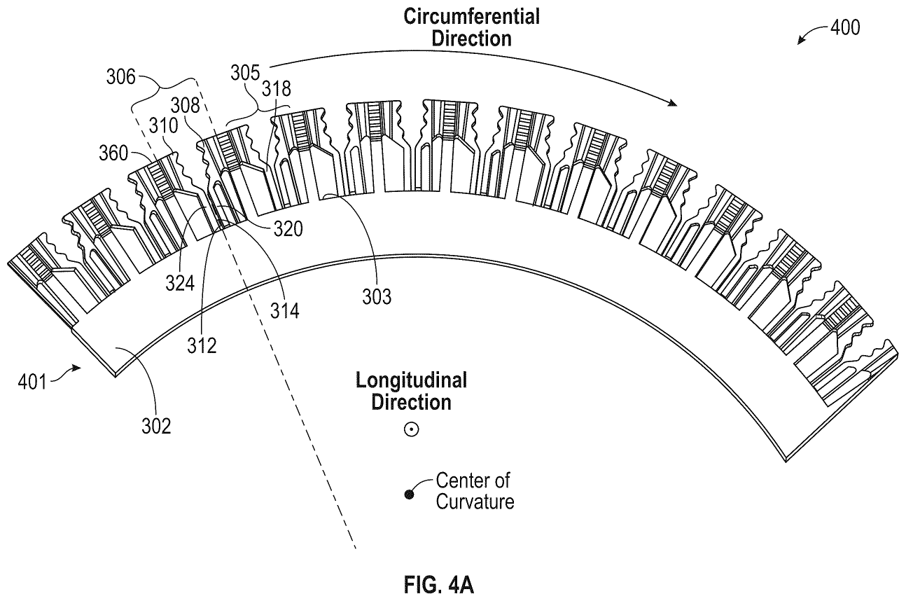

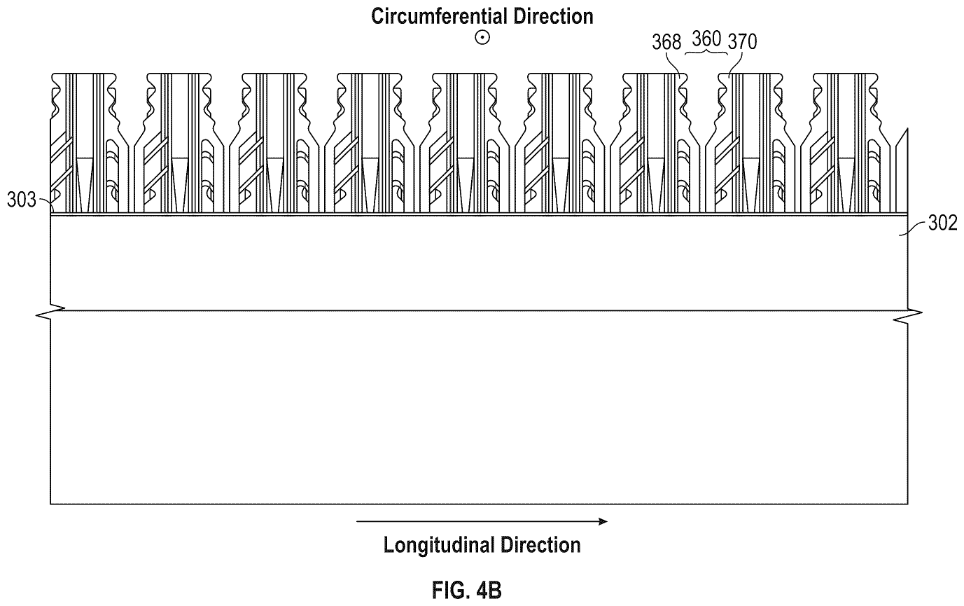

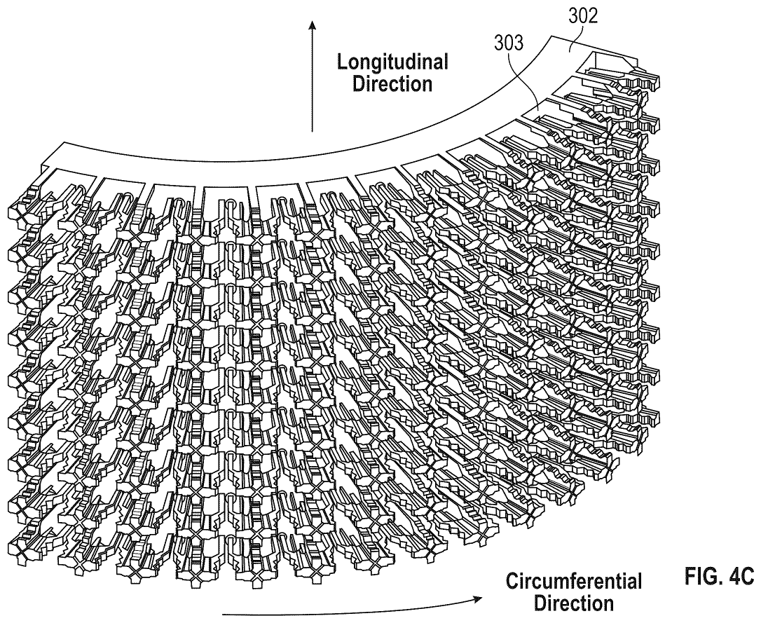

In some embodiments, the unit cell 302 is one of a plurality of unit cells that form a phased array antenna. The unit cells can be arranged to form phased array antennas of various shapes, including cylinders, semicylinders, spheres, etc. FIG. 4A illustrates a first side view (looking into the longitudinal direction of a cylindrical phased array antenna) of a module 401 of a phased array antenna 400. In some embodiments, the module 401 is a portion of a cylindrical or semicylindrical phased array antenna that can be assembled into a cylindrical or semicylindrical phased array antenna by attaching module 401 with other modules. The module 401 includes a plurality of radiating elements, such as radiating elements 305 and 306 oriented in a first direction and a plurality of radiating elements, such as radiating element 360, oriented in a second direction. Each of the radiating elements oriented in the first direction include a signal ear and a ground ear, such as signal ear 308 and ground ear 310 of radiating element 306, projecting outwardly from a first curved surface 303 of the base plate 302. The signal ear and ground ear of each radiating element oriented in the first direction, such as signal ear 308 and ground ear 310 of radiating element306 are spaced apart from one another in a circumferential direction of the first curved surface of the base plate 302 and include any of the features described above with reference to FIGS. 3A-3C. FIG. 4B illustrates a second side view (looking into the circumferential direction of a cylindrical phased array antenna) of a module 401 of a phased array antenna 400 that more clearly depicts the radiating elements oriented in the second direction, such as radiating element 360. Each of the radiating elements oriented in the second direction include a signal ear and a ground ear, such as signal ear 368 and ground ear 370 of radiating element 360. The signal ear and ground ear of each radiating element oriented in the second direction may include any of the features described above with reference to the signal ear 368 and ground ear 370 illustrated in FIGS. 3A-3C.

FIG. 4C illustrates an isometric view of the module 401. As shown in FIG. 4C the plurality of radiating elements oriented in the first direction and plurality of radiating elements oriented in the second direction are arranged in a rectangular pattern arrayed about the curved surface 303. As described above, this pattern is exemplary in nature and could be modified without deviating from the scope of the disclosure. For instance, radiating elements oriented in the first direction and radiating elements oriented in the second direction could be rearranged by rotating both of the sets of radiating elements such that both sets of radiating elements are oriented partially in the antenna's longitudinal direction and partially in the antenna's circumferential direction. Such an embodiment is illustrated in FIG. 2.

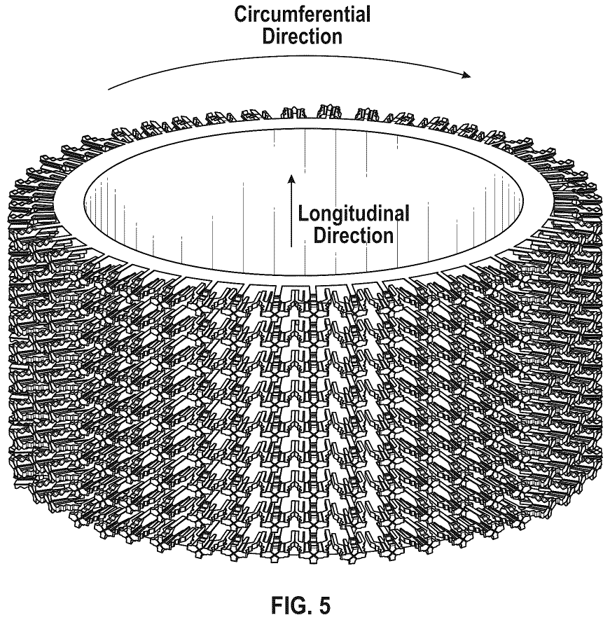

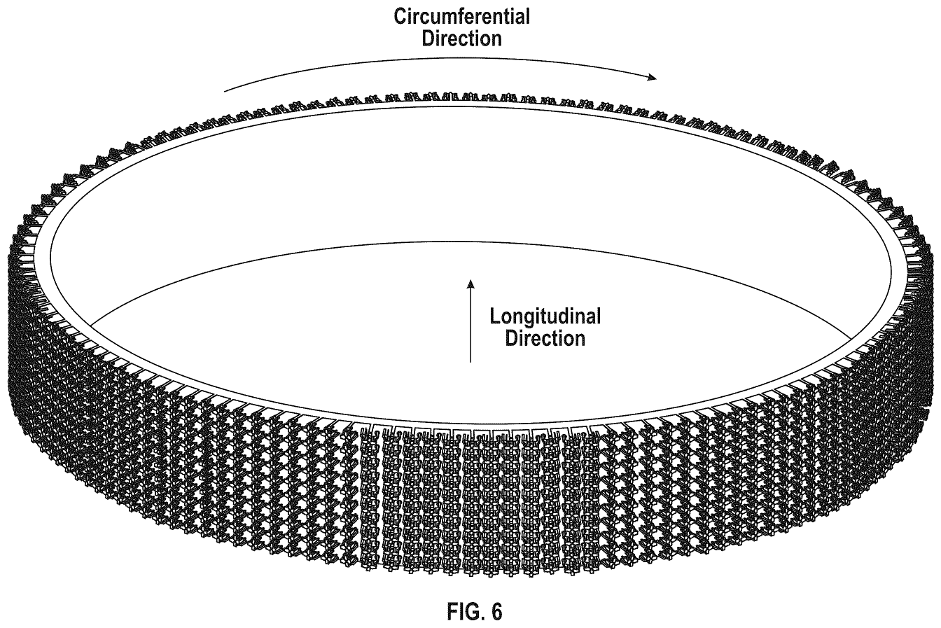

In some embodiments, the module 401 may be operated independently as a semicylindrical phased array antenna. In some embodiments, the module 401 is combined with a plurality of other modules to form a cylindrical or semicylindrical phased array antenna and may be operated either independently or in combination with the modules tiles forming the cylindrical phased array antenna, for instance as shown in FIGS. 5 and 6. In some embodiments, the module 401 is configured for mounting to a land, air, or water vehicle. In some embodiments, the module 401 is configured for mounting to a building. In some embodiments, a semicylindrical phased array antenna formed by assembling one or more modules 401 may be configured for mounting to a floatation device. In some embodiments, the floatation device may be configured to be at least partially submerged in water such that the semicylindrical phased array antenna formed by assembling one or more modules 401 is exposed above the surface of the water.

FIG. 5 illustrates a cylindrical phased array antenna 500. Cylindrical phased array 500 is configured to operate in a frequency range of 1-6 GHz based partially on a radiating element height of 1.455 inches and unit cell spacing of 1.005 inches. FIG. 6 illustrates a cylindrical phased array antenna 600. Cylindrical phased array antenna 600 is configured to operate in a frequency range of 3-18 GHz based partially on a radiating element height of 0.485 inches and a unit cell spacing of 0.335 inches. As demonstrated by cylindrical phased array antennas 500 and 500, reduction in unit cell spacing and radiating element size result in higher frequency operation. Accordingly, any number of target frequencies and bandwidths can be achieved with minimal impact on the diameter of the cylinder by adjusting the radiating element size and unit cell spacing. In some embodiments, multiple cylindrical phased array antennas may be stacked on top of one another to target additional frequencies and/or bandwidths, for instance, as illustrated in FIG. 9. By stacking cylindrical phased array antenna 500 and cylindrical phased array antenna 600, 360 degrees of coverage from 1-18 GHz would be obtained. Additionally, cylindrical phased array antennas 500 and 600 can be operated as directional antennas, for instance, by exciting only one single sector of the antenna, or all sectors or radiating elements can be operated together to form an omnidirectional beam. Full cylindrical phased array antennas, such as those illustrated in FIGS. 5 and 6, may be advantageous over conventional phased array antennas in a variety of environments. For instance, cylindrical arrays can be mounted to various land, air, or water vehicles (e.g., to the mast of a ship, the top of an unmanned land vehicle) or buildings, to provide full 360 degree coverage using a single phased array antenna.

### Concave Phased Array Antenna

Described above were various convex shaped phased array antennas. In some embodiments, a semicylindrical or semispherical concave phased array antenna (or segments thereof) may be desirable. As described above, gain performance of a conventional phased array antenna is optimal perpendicular to the planar array (i.e., at broadside) and decreases as the angle relative to broadside increases. One way to mitigate this loss in gain is using convex cylindrical phased array antennas. Another is using a concave semicylindrical or semispherical phased array antenna combined with a cylindrical dielectric lens, which serves as a medium to increase the gain of the antenna. Signals generated by radiating elements of a concave semicylindrical or hemispherical phased array antenna can be directed toward a dielectric lens positioned near the center of curvature of the phased array antenna. In some embodiments, the phased array antenna may include a switching network. The switching network may be used to transmit a signal using a single radiating element. In some embodiments, the area gain of the full dielectric lens is obtained by exciting a single element. In some embodiments, the switching network can be coupled to groups of radiating elements and groups of radiating elements can simultaneously transmit signals through the dielectric lens.

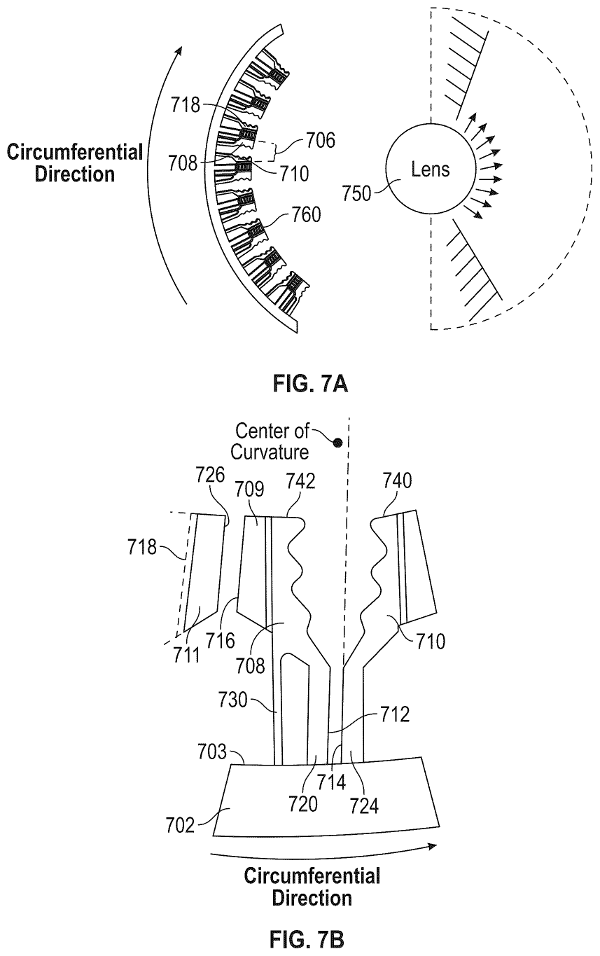

FIG. 7A illustrates a side view of a concave phased array antenna 700, according to some embodiments. In some embodiments, phased array antenna 700 is a semicylinder. In some embodiments, phased array antenna 700 is hemispherical. Phased array antenna 700 includes a plurality of radiating elements 706 oriented in a first direction and radiating elements 760 oriented in a second direction. A first radiating element 706 includes a signal ear 708 and a ground ear 710 (as shown labeled in the detail view of radiating element 706 in FIG. 7B) projecting outwardly from a first curved surface 703 of the base plate 702. In the exemplary phased array antenna 700 of FIG. 7, the signal ear 708 and ground ear 710 of radiating element 706 are spaced apart from one another in a circumferential direction of the first curved surface of the base plate 702.

In some embodiments, a dielectric lens 750 is positioned inside a radius of curvature defined by curved surface 703. In some embodiments, dielectric lens 750 is a cylindrical lens. In some embodiments, dielectric lens 750 is a spherical lens. In some embodiments, a centroid of dielectric lens 750 is positioned at the center of curvature of the phased array antenna 700. As described above, signals generated by radiating elements 706 and radiating elements 760 of phased array antenna 700 are directed toward dielectric lens 750. In some embodiments, exciting one or more of the radiating elements 706 and/or radiating elements 760 causes signals transmitted by the excited elements to pass through the lens 750. A gain of the signals passing through the lens 750 is increased, thus improving the efficiency of signal transmission.

In some embodiments, the signal ears 708 includes a first surface 712 that faces a first surface 714 of the ground ears 710 and is parallel to the first surface 714 of the ground ears 710, as shown in the detail view of FIG. 7B. In some embodiments, the signal ears 708 includes a first post 720 and the ground ears includes a post 724. In some embodiments, the first post 720 of the signal ear 708 includes the first surface 712 of the signal ear and the post 724 of the ground ear 710 includes the first surface 714 of the ground ear that faces the first surface 712 of the signal ear 708. Accordingly, the signal ear 708 and ground ear 710 may respectively include posts projecting outwardly from the first curved surface 703 of base plate 702, and the surfaces 712 and 714 of the respective posts 720 and 724 that face one another are parallel to each other.

In some embodiments, at least one of the first surface 712 of the signal ear 708 and the first surface 714 of the ground ear 710 do not intersect a center of curvature of the first curved surface 703. As described, the respective surfaces 712 and 714 of posts 720 and 724 are parallel to one another extending outwardly from the base plate 702. Accordingly, a plane on which each of the surfaces 712 and 714 respectively lie may project outwardly from the base plate 702 and toward the center of curvature of the first curved surface 703. However, because the respective surfaces 712 and 714 are parallel to one another, at least one of the planes formed by the respective surfaces does not intersect the center of curvature of the first curved surface.

In some embodiments, signal ear 708 includes a second surface 716 that is positioned to capacitively couple with a first surface 726 of a ground ear 718 of an adjacent radiating element 706 oriented in the first direction. The second surface 716 of the signal ear 708 faces away from the first surface 712 of the signal ear 708 and is not parallel to the first surface 712 of the signal ear 708. The second surface 716 of signal ear 708 is positioned on a capacitive coupling portion 709 of the signal ear 708 that extends toward a capacitive coupling portion 711 of the ground ear 718 of the second radiating element in the circumferential direction. In some embodiments, the capacitive coupling portions 709 and 711 include triangularly shaped portions such that other surfaces of the capacitive coupling portions 709 and 711 can capacitively couple with surfaces on the triangularly shaped portions of the capacitive coupling portions of radiating elements oriented orthogonally to radiating element 706. In some embodiments, a bottom surface (i.e., closer to the base plate 702) of the each of the respective capacitive coupling portions 709 and 711 is larger than a top surface (i.e., further from the base plate 702) of the each of the respective capacitive coupling portions 709 and 711 to account for the curvature of the base plate 702 and maintain a constant gap width between surfaces 716 and 726.

In some embodiments, an outer end 740 of ground ear 710 and an outer end 742 of signal ear 708 are aligned in an arc. The arc may be concentric with the first curved surface 703 of the base plate 702. In some embodiments the base plate 702 forms at least a portion of a hollow semicylinder or a hollow hemisphere. Accordingly, the base plate 702 of the phased array antenna 700 may be a hollow semicylindrical or hollow hemispherical base plate, and the radiating elements arrayed about the circumference of curved surface 703 of the base plate 702 may form a semicylindrical or hemispherical array of radiating elements.

In some embodiments, the first post 720 of signal ear 708 is electrically isolated from the base plate 702, as shown in FIG. 7B. Post 720 may extend beyond the first curved surface 703 of the base plate 702 into the base plate to connect to a feed line (not shown). The first post 720 may connect to the feed line by contacting a connector, such as an elastomeric connector, that is electrically connected to the feed line. In some embodiments, post 724 of ground ear 710 is connected to the first curved surface 703 of the base plate 702 and as such provides a path to ground between the ground ear 710 and the base plate 702. In some embodiments, the post 724 is directly integrated into the base plate 302. In some embodiments, signal ear 708 includes a second post 730 that is connected to base plate 702. In some embodiments, the second post 730 is directly integrated into the base plate 702. In other embodiments, post 730 can be removably attached to base plate 702. In some embodiments, the second post 730 of signal ear 708 serves as a support member for signal ear 708. In some embodiments, second post 730 is electrically isolated from the base plate. In some embodiments, second post 730 is electrically connected to base plate 702 and provides a path to ground for signal ear 708. It should be understood that the second post 730 of signal ear 708 is optional, and the signal ear 708 may be electrically isolated from the base plate.

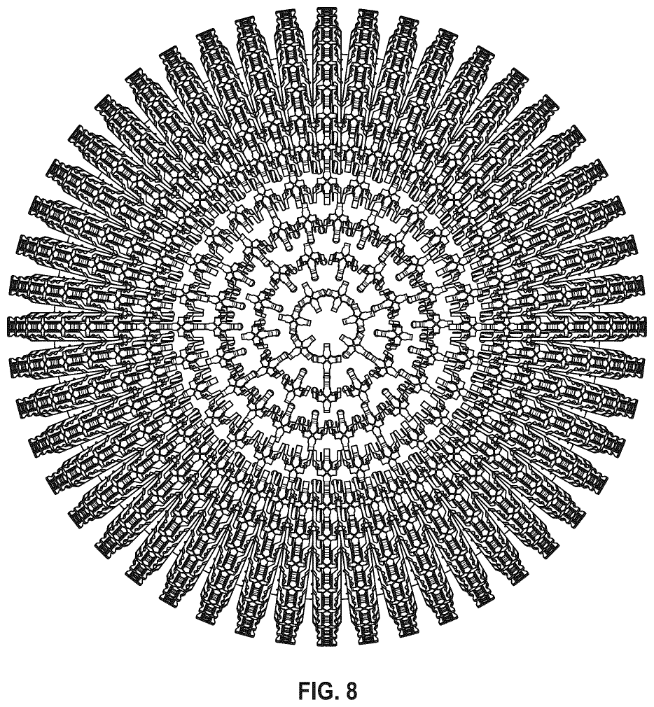

As described throughout, in various embodiments, the phased array antennas described herein may be spherical phased array antennas. A spherical phased array antenna may be desirable due to its ability to provide omnidirectional coverage around the circumference of the sphere. Any of the exemplary phased array antenna components described herein may be implemented on a spherical phased array antenna. An exemplary spherical phased array antenna 800 according to some embodiments is illustrated in FIG. 8. Spherical phased array antenna 800 includes a plurality of radiating elements, such as radiating element 806. In some embodiments, radiating element 806 includes any of the features described above, for instance, with reference to radiating element 306 of unit cell 301 described with reference to FIG. 3A.

As described above with reference to FIGS. 5 and 6, in some embodiments, cylindrical phased array antennas may be stacked on top of one another to target additional frequencies and/or bandwidths. FIG. 9 illustrates an exemplary phased array antenna that includes two cylindrical phased array antennas 902 and 904 stacked on top of one another. In some embodiments, phased array antenna 902 may be configured to operate in a first frequency range and phased array antenna 904 may be configured to operate in a second frequency range. By stacking the phased array antennas 902 and 904, coverage can be provided for both the first and second frequency range. For example, phased array antenna 902 may be configured to operate in a frequency range of 1-6 GHz based at least in part on a height of the radiating elements and the unit cell spacing of the radiating elements and unit cells provided on the phased array antenna 902. Phased array antenna 904 may be configured to operate in a frequency range of 3-18 GHz based at least in part on a radiating element height and a unit cell spacing of the radiating elements and unit cells disposed on phased array antenna 904. It should be understood that any frequency range could be targeted by adjusting the radiating element height and/or unit cell spacing, and that additional phased array antennas could be stacked upon antennas 902 and 904 to target additional frequency ranges.

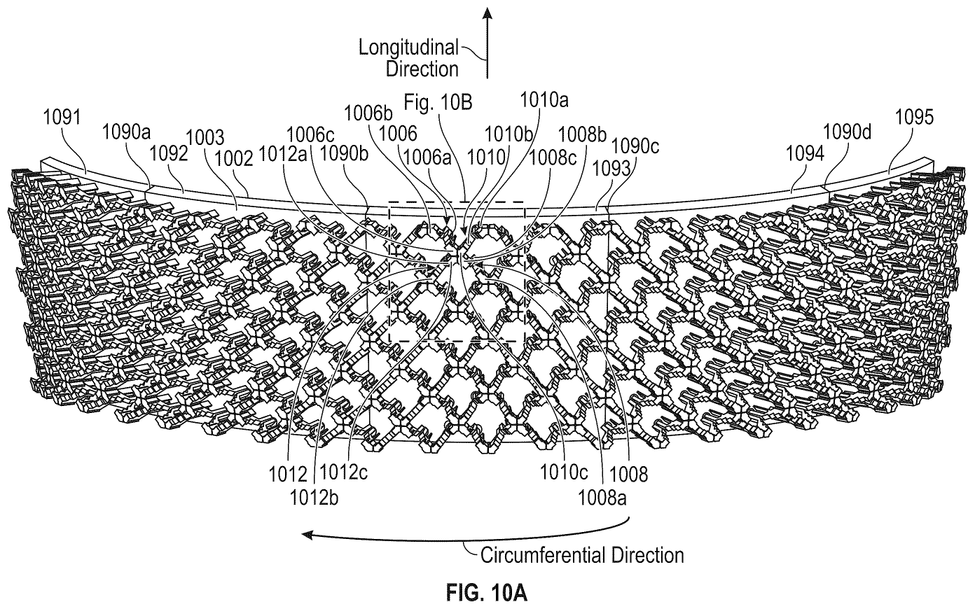

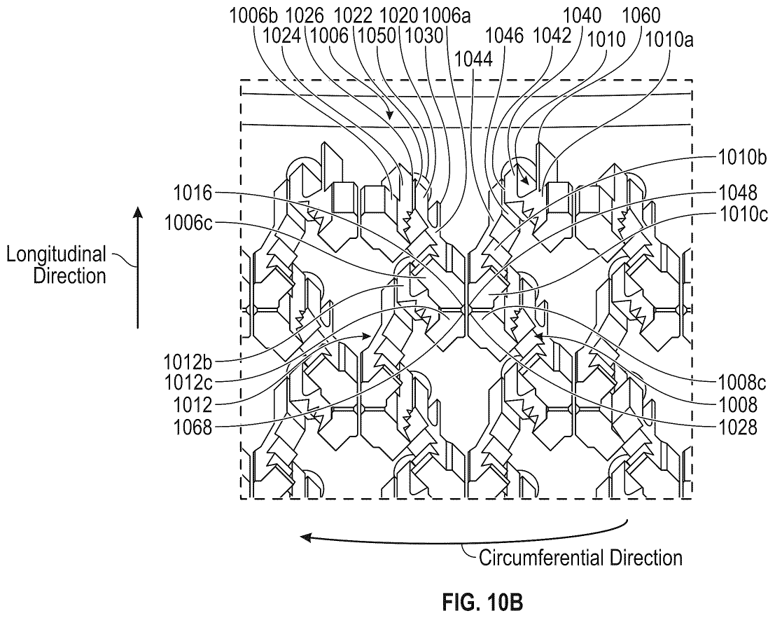

FIG. 10A illustrates exemplary aspects of a cylindrical or semi-cylindrical phased array antenna according to some examples. FIG. 10B illustrates a detail view of aspects of the radiating elements shown in FIG. 10A. The semi-cylindrical phased array antenna shown in FIG. 10A includes a plurality of semi-cylindrical tiles, including tile 1091, tile 1092, tile 1093, tile 1094, and tile 1095. Tile 1091 is connected to tile 1092 at seam 1090a. Tile 1092 is connected to tile 1093 at seam 1090b. Tile 1093 is connected to tile 1094 at seam 1090c. Tile 1094 is connected to tile 1095 at seam 1090d. While the semi-cylindrical phased array antenna of FIG. 10A includes five tiles, it should be understood that any number of tiles could be connected together. For instance, a plurality of semi-cylindrical tiles could be assembled to form a cylindrical phased array antenna. Further, while the tiles depicted in FIG. 10A are semi-cylindrical, it should be understood that other shapes are possible. For instance, a plurality of tiles could be assembled to form a spherical phased array antenna. The modular phased array antenna shown in FIG. 10A can be easily assembled and disassembled. Tiles can be quickly added or removed for different transmissions requirements and/or use cases as needed.

The phased array antenna shown in FIG. 10A includes a plurality of radiating elements oriented in a first direction, including radiating element 1006 and radiating element 1008, and a plurality of radiating elements oriented in a second direction, including radiating element 1010 and radiating element 1012. The radiating elements of FIGS. 10A and 10B are arranged similarly to those shown in FIG. 2. The first direction includes a circumferential component (e.g., along a curved surface) and a longitudinal component (e.g., along a height). The second direction also includes a circumferential component and a longitudinal component. The first direction is orthogonal to the second direction. The radiating elements of the cylindrical or semi-cylindrical phased array antenna shown in FIG. 10 may include various aspects of the radiating elements of the various embodiments described throughout.

Radiating element 1006 includes a signal ear 1006a and ground ear 1006b projecting outwardly from the curved surface 1003 of a base plate 1002. Signal ear 1006a is spaced apart from ground ear 1006b in the first direction. The signal ear 1006a is thus spaced apart from ground ear 1006b in a direction having both a circumferential component and a longitudinal component along the curved surface 1003 of base plate 1002.

As illustrated in FIG. 10B, signal ear 1006a includes a first surface 1022 that faces a first surface 1026 of the ground ear 1006b and is parallel to the first surface 1026 of the ground ear 1006b. In some examples, the signal ear 1006a includes a first post 1020 and the ground ear 1006b includes a post 1024. The first post 1020 of the signal ear 1006a includes the first surface 1022 of the signal ear 1006a and the post 1024 of the ground ear 1006b includes the first surface 1026 of the ground ear 1006b that faces the first surface 1022 of the signal ear 1006a. Accordingly, the signal ear 1006a and ground ear 1006b may respectively include posts projecting outwardly from the first curved surface 1003 of base plate 1002, and the surfaces 1022 and 1026 of the respective posts 1020 and 1024 that face one another are parallel to each other. The two surfaces 1022 and 1026 are spaced apart, forming a gap.

In some embodiments, signal ear 1006a includes a second surface 1016 that is positioned to capacitively couple with a first surface 1028 of a ground ear 1008b of an adjacent radiating element 1008. Adjacent radiating element 1008 is also oriented in the first direction and is spaced apart from radiating element 1006 in the first direction. The second surface 1016 of the signal ear 1006a faces away from the first surface 1022 of the signal ear 1006a. As shown in FIG. 10A, the signal ear 1006a includes a capacitive coupling portion 1006c that extends toward a capacitive coupling portion 1008c of the ground ear 1008b of the second radiating element 1008. The second surface 1016 of signal ear 1006a is positioned on capacitive coupling portion 1008c. The capacitive coupling portions 1006c and 1008c may include triangularly shaped portions such that other surfaces of the triangularly shaped portions of the capacitive coupling portions 1006c and 1008c can capacitively couple with surfaces on triangularly shaped capacitive coupling portions of radiating elements oriented orthogonally to radiating element 1006, including radiating element 1010 and radiating element 1012.

The capacitive coupling portion 1006c of the signal ear 1006a and the capacitive coupling portion 1008c of ground ear 1008b are configured to maintain a gap having a constant width between the capacitive coupling surfaces 1016 and 1028 along the length of surfaces 1016 and 1028. To maintain constant gap width between surfaces 1016 and 1028 capacitive coupling portion 1006c of signal ear 1006a may be a first size and capacitive coupling portion 1008c of ground ear 1008b may be a second size. Capacitive coupling portion 1006c of signal ear 1006a may be relatively larger than capacitive coupling portion 1008c of ground ear 1008b to maintain the gap having a constant width between surfaces 1016 and 1028, accounting for the curvature of base plate 1002. Maintaining constant gap width improves capacitive coupling between surfaces 1016 and 1028, thus impacting antenna performance.

The first post 1020 of signal ear 1006a is electrically isolated from the base plate 1002. Post 1020 may extend beyond the first curved surface 1003 of the base plate 1002 into the base plate to connect to a feed line (not shown). Post 1020 may extend into the base plate 1002 via an aperture 1050 in base plate 1002. Post 1024 of ground ear 1006b is connected to the first curved surface 1003 of the base plate 1002 and provides a path to ground between the ground ear 1006b and the base plate 1002. The post 1024 may be directly integrated into the base plate 1002. In some embodiments, signal ear 1006a includes a second post 1030 that is connected to base plate 1002. The second post 1030 may be directly integrated into the base plate 1002. Post 1030 could alternatively be removably attached to base plate 1002. The second post 1030 of signal ear 1006a serves as a support member for the signal ear 1006a.

As shown in FIG. 10A, radiating element 1010 is oriented orthogonally to radiating elements 1006 and 1008 in the second direction. Radiating element 1010 includes a signal ear 1010a and ground ear 1010b projecting outwardly from the curved surface of a curved surface 1003 of a base plate 1002. Signal ear 1010a is spaced apart from ground ear 1010b in the second direction. The signal ear 1010a is accordingly spaced apart from ground ear 1010b in a direction having both a circumferential component and a longitudinal component along the curved surface of base plate 1003.

As illustrated in FIG. 10B, signal ear 1010a includes a first surface 1042 that faces a first surface 1046 of the ground ear 1010b and is parallel to the first surface 1046 of the ground ear 1010b. In some examples, the signal ear 1010a includes a first post 1040 and the ground ear 1010b includes a post 1044. The first post 1040 of the signal ear 1010a includes the first surface 1042 of the signal ear 1010a and the post 1044 of the ground ear 1010b includes the first surface 1026 of the ground ear 1010b that faces the first surface 1022 of the signal ear 1010a. Accordingly, the signal ear 1010a and ground ear 1010b may respectively include posts projecting outwardly from the first curved surface 1003 of base plate 1002, and the surfaces 1042 and 1046 of the respective posts 1040 and 1044 that face one another are parallel to each other.

In some examples, ground ear 1010b includes a second surface 1048 that is positioned to capacitively couple with a surface 1068 of a signal ear 1012b of an adjacent radiating element 1012. Adjacent radiating element 1012 is also oriented in the second direction and is spaced apart from radiating element 1010 in the second direction. The second surface 1048 of the ground ear 1010b faces away from the first surface 1044 of the ground ear 1010b. The ground ear 1010b includes a capacitive coupling portion 1010c that extends toward a capacitive coupling portion 1012c of the signal ear 1012a of radiating element 1012. The second surface 1048 of ground ear 1010b is positioned on capacitive coupling portion 1010c. The capacitive coupling portions 1010c and 1012c may include triangularly shaped portions such that other surfaces of the capacitive coupling portions 1010c and 1012c can capacitively couple with surfaces on the triangularly shaped portions of capacitive coupling portions of radiating elements oriented orthogonally to radiating elements 1010 and 1012, including radiating element 1006 and radiating element 1008.

The capacitive coupling portion 1010c of the ground ear 1010b and the capacitive coupling portion 1012c of signal ear 1012a are configured to maintain a gap having a constant width between the capacitive coupling surfaces 1048 and 1068 along the length of surfaces 1048 and 1068. To maintain constant gap width between surfaces 1048 and 1068, capacitive coupling portion 1010c of ground ear 1010b may be configured to be a first size and capacitive coupling portion 1012b of signal ear 1012a may be configured to be a second size. Capacitive coupling portion 1010c of ground ear 1010b may be relatively smaller than capacitive coupling portion 1012c of signal ear 1012a to maintain the gap having a constant width between surfaces 1048 and 1068, accounting for the curvature of base plate 1002. Maintaining constant gap width improves capacitive coupling between surfaces 1048 and 1068, thus impacting antenna performance.

The first post 1040 of signal ear 1010a is electrically isolated from the base plate 1002. Post 1040 may extend beyond the first curved surface 1003 of the base plate 1002 into the base plate to connect to a feed line (not shown). Post 1040 may extend into the base plate 1002 via another aperture 1050 in base plate 1002. Post 1044 of ground ear 1010b is connected to the first curved surface 1003 of the base plate 1002 and provides a path to ground between the ground ear 1010b and the base plate 1002. Post 1044 may be directly integrated into the base plate 1002. In some embodiments, signal ear 1010a includes a second post 1060 that is connected to base plate 1002. The second post 1060 may be directly integrated into the base plate 1002. Post 1060 could alternatively be removably attached to base plate 1002. The second post 1060 of signal ear 1010a serves as a support member for the signal ear 1010a.

While the description above has made reference to specific phased array antenna shapes, including convex and concave cylindrical, semicylindrical, spherical and hemispherical phased array antennas, it should be understood that the description provided above could apply equally to conformal phased array antennas of a variety of shapes and sizes. For instance, an exemplary phased array antenna including any of the features described throughout could be formed into a conical or dome shape for a nose cone, wing, or structural surface of an aerial or land vehicle.

1. A phased array antenna comprising:
a base plate comprising a first curved surface; and
a plurality of radiating elements, wherein a first radiating element of the plurality of radiating elements comprises:
a signal ear projecting outwardly from the first curved surface; and
a ground ear projecting outwardly from the first curved surface and spaced in at least a circumferential direction of the first curved surface of the base plate from the signal ear,
wherein a first surface of the signal ear facing a first surface of the ground ear is parallel to the first surface of the ground ear.

2. The phased array antenna of claim 1, wherein a second surface of the signal ear is configured to capacitively couple with a first surface of a ground ear of a second radiating element, wherein the second surface of the signal ear faces away from the first surface of the signal ear and is not parallel to the first surface of the signal ear.

3. The phased array antenna of claim 2, wherein the second surface of the signal ear of the first radiating element is parallel to the first surface of the ground ear of the second radiating element.

4. The phased array antenna of claim 1, wherein a plane associated with at least one of the first surface of the signal ear and the first surface of the ground ear does not intersect a center of curvature of the first curved surface.

5. The phased array antenna of claim 1, wherein an outer end of the ground ear and an outer end of the signal ear are aligned in an arc.

6. The phased array antenna of claim 5, wherein the arc is concentric with the first curved surface of the base plate.

7. The unit cell of claim 1, wherein the base plate forms at least a portion of a hollow cylinder.

8. The unit cell of claim 1, wherein the signal ear comprises a first post projecting outwardly from the first curved surface, wherein the first post is electrically isolated from the base plate.

9. The phased array antenna of claim 8, wherein the first post comprises the first surface of the signal ear facing the first surface of the ground ear.

10. The phased array antenna of claim 8, wherein the signal ear comprises a second post projecting outwardly from the first curved surface of the base plate, wherein the second post is directly integrated into the base plate.

11. The phased array antenna of claim 8, wherein the first post extends beyond the first curved surface of the base plate into the base plate to connect to a feed line.

12. The phased array antenna of claim 8, wherein the first post connects to the feed line by contacting a connector electrically connected to the feed line.

13. The phased array antenna of claim 1, wherein the ground ear comprises a post projecting outwardly from the first curved surface of the base plate, wherein the post is directly integrated into the base plate.

14. The phased array antenna of claim 13, wherein the post comprises the first surface of the ground ear facing the first surface of the signal ear.

15. The phased array antenna of claim 1, wherein the signal ear comprises a first post and the ground ear comprises a post, wherein the first post of the signal ear comprises the first surface of the signal ear and wherein the post of the ground ear comprises the first surface of the ground ear.

16. The phased array antenna of claim 1, further comprising a third radiating element, wherein the third radiating element projects outwardly from the first curved surface of the base plate, wherein the third radiating element is positioned orthogonally to the first radiating element.

17. The phased array antenna of claim 13, wherein the third radiating element comprises a signal ear and a ground ear, and wherein a plane associated with first surface of the signal ear of the third radiating element intersects a center of curvature of the first curved surface, wherein the first surface of the signal ear of the third radiating element is positioned on a post of the signal ear of the third radiating element facing a surface on a post of the ground ear of the third radiating element.

18. The phased array antenna of claim 1, wherein the base plate of the phased array antenna is a semicylinder.

19. The phased array antenna of claim 1, wherein the base plate of the phased array antenna is a cylinder.

20. The phased array antenna of claim 1, wherein the base plate of the phased array antenna is a hollow sphere.

21. The phased array antenna of claim 1, wherein the phased array antenna is configured for mounting to a vehicle.

22. The phased array antenna of claim 1, wherein the ground ear is spaced in a longitudinal direction of the first curved surface of the base plate from the signal ear.
